(19) United States
(12) Patent Application Publication
(10) Pub. No.: US 2012/0246042 A1
(43) Pub. Date: Sep. 27, 2012

(54) SYSTEMS AND METHODS FOR GENERATING A UTILITY BILL

(76) Inventor: Nathan Bowman Littrell, Gardnerville, NV (US)

(21) Appl. No.: 13/052,366

(22) Filed: Mar. 21, 2011

(51) Int. Cl. G06Q 30/00

(52) U.S. Cl. 705/34

(57) ABSTRACT

A system includes a meter for monitoring energy consumed by an energy consumer and a first computer coupled to the meter. The first computer receives from the meter a plurality of measurements representative of energy consumed during a billing period. The system also includes a second computer that generates a signal representative of a critical peak pricing rate for energy consumed during a critical peak pricing event, and a third computer coupled to the first computer and to the second computer. The third computer calculates a first consumption amount representative of energy consumed during the critical peak pricing event, calculates a second consumption amount representative of energy consumed other than during the critical peak pricing event, and generates a bill including a flat pricing rate for the second consumption amount and the critical peak pricing rate for the first consumption amount.

### BACKGROUND OF THE INVENTION

The present application relates generally to power systems and, more particularly, to systems and methods for generating a utility bill.

Demand for electricity by customers generally varies over the course of any particular day. Such demand also generally varies by season (e.g., demand for electricity may be higher during the hot summer months as compared to the demand in the more mild spring months). Such demand may also grow over time in a particular market as the population and/or industry grows. Increasing electricity generation capacity can be capital intensive and take many years of planning and construction.

Rather than undertake such significant capital investments, planning and construction, some utilities impose a rate structure that discourages use of electricity during peak demand periods. For example, a utility customer who subscribes to such a rate structure agrees to reduced energy consumption during such peak demand periods and in return, receives a favorable rate. In the context of a residential application, for example, this means that during peak demand periods, the utility may choose to not supply electricity to the residential hot water heater. The hot water heater is energized during off peak periods. Such rate structures also are available in commercial applications and may relate to many different types of equipment that consume energy.

Some electric utility companies utilize so-called “smart grid” or Advanced Metering Infrastructure (AMI) power networks. Using an AMI network, a utility company may communicate with individual loads within a customer's premises and selectively reduce energy supplied during peak usage periods. As such, the utility company may reduce energy supplied to low priority loads (e.g., a hot water heater), while maintaining energy supplied to high priority loads (e.g., a freezer).

In addition, some utilities employ a demand response system that facilitates managing energy supply during periods of reduced power generation capacity and/or reduced power distribution capacity. Such situations may develop, for example, in the event a power generation source is taken off the energy distribution grid for servicing. In such situations, the demand response systems transmit demand response requests to a dashboard or another device (e.g., a switch) associated with at least one load at a customer's premises. The demand response requests cause the connected loads to be taken off the grid (e.g., the switch is opened so that no energy is supplied to such loads) during the period of reduced power generation capacity and/or reduced power distribution capacity.

At least some known power utility companies broadcast demand response requests to a plurality of dashboards or other devices associated with loads coupled to the power distribution network. Such broadcasted demand response requests may not necessarily reduce energy consumption in the specific portions of the power distribution network that experience reduced power distribution and/or transmission capacity.

By managing energy consumption during such peak demand periods as well as periods of reduced power generation/distribution capacity as described above, a utility may avoid making the significant capital investments required to construct and operate additional power generation facilities. Over time, of course, new power generation facilities may be needed in the event demand continues to grow and exceed capacity. In addition, while some utility customers may be willing to subscribe to a rate structure that enables the utility to disconnect energy supply to certain appliances/equipment during peak periods, such rate structures are not necessarily satisfactory.

### BRIEF DESCRIPTION OF THE INVENTION

In one embodiment, a system is provided that includes a meter for monitoring energy consumed by an energy consumer and a first computer coupled to the meter. The first computer receives from the meter a plurality of measurements representative of energy consumed during a billing period. The system also includes a second computer that generates a signal representative of a critical peak pricing rate for energy consumed during a critical peak pricing event, and a third computer coupled to the first computer and to the second computer. The third computer calculates a first consumption amount representative of energy consumed during the critical peak pricing event, calculates a second consumption amount representative of energy consumed other than during the critical peak pricing event, and generates a bill including a flat pricing rate for the second consumption amount and the critical peak pricing rate for the first consumption amount.

In another embodiment, a billing system is provided that includes a processor configured to receive a plurality of measurements representative of energy consumed during a billing period, and receive a signal representative of a critical peak pricing rate for energy consumed during a critical peak pricing event. The billing system is configured to calculate a first consumption amount representative of energy consumed by an energy consumer during the critical peak pricing event from the plurality of measurements, calculate a second consumption amount representative of energy consumed by the energy consumer other than during the critical peak pricing event from the plurality of measurements, and generate a bill that includes a flat pricing rate for the second consumption amount and the critical peak pricing rate for the first consumption amount.

In yet another embodiment, a method for generating a bill is provided that includes receiving a signal representative of a critical peak pricing rate for energy consumed during a critical peak pricing event, determining a first amount of energy consumed by an energy consumer during the critical peak pricing event, and determining a second amount of energy consumed by the energy consumer other than during the critical peak pricing event. A bill is generated that includes a flat pricing rate for the first amount and the critical peak pricing rate for the second amount.

### BRIEF DESCRIPTION OF THE DRAWINGS

FIG. 1 is a block diagram of an exemplary system for use with a utility company.

FIG. 2 is a block diagram of an exemplary billing system that may be used with the system shown in FIG. 1.

FIG. 3 is a block diagram of an exemplary billing algorithm that may be used with the billing system shown in FIG. 2.

FIG. 4 is a graphical view of an exemplary energy consumption history of an energy consumer.

### DETAILED DESCRIPTION OF THE INVENTION

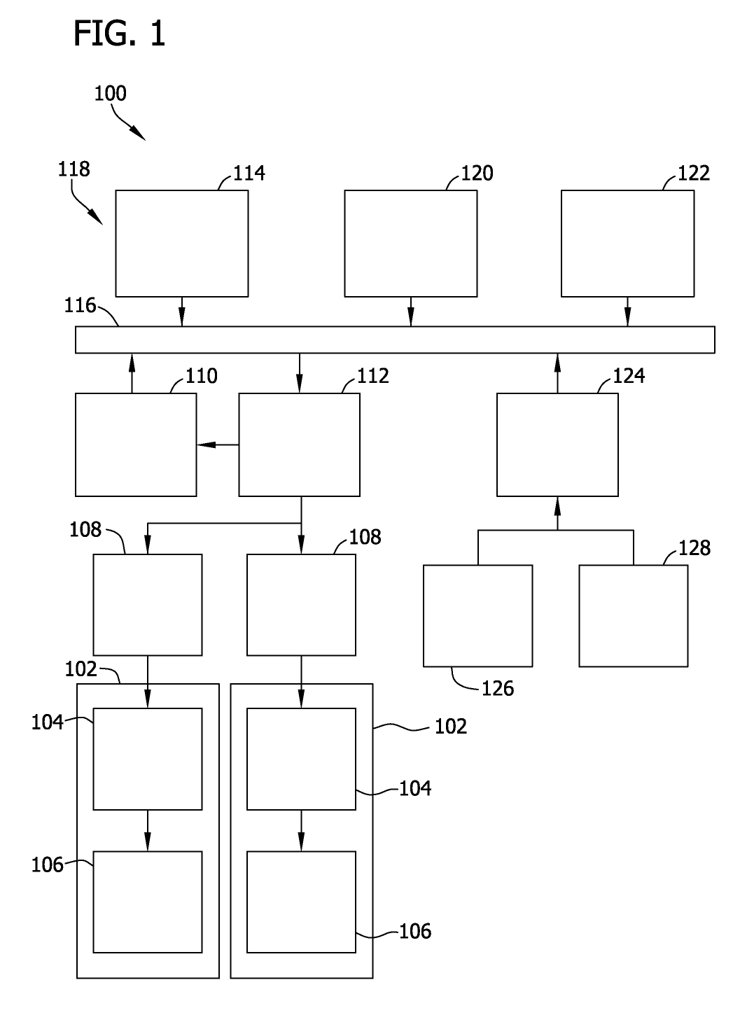

FIG. 1 illustrates an exemplary system 100 that may be used with a utility company (not shown), such as an electric utility company. Moreover, in the exemplary embodiment, the utility company provides energy, such as electricity, to a plurality of locations 102. Alternatively, energy provided by the utility company may include natural gas, propane, and/or any other form of energy and/or product usable for generating energy. Locations 102 may include, but are not limited to only including, a residence, an office building, an industrial facility, and/or any other building or location that receives energy from the utility company. In the exemplary embodiment, system 100 monitors the delivery of energy from the utility company to locations 102.

In the exemplary embodiment, each location 102 includes at least one network device 104 and at least one energy consumer 106 coupled to network device 104. As used herein, the term “couple” is not limited to a direct mechanical and/or electrical connection between components, but may also include an indirect mechanical and/or electrical connection between components. In the exemplary embodiment, network device 104 includes a dashboard, a console, and/or any other device that enables system 100 to function as described herein. Alternatively, network device 104 may be a receiver or a transceiver coupled to or integrated within an associated energy consumer 106. Network device 104 transmits and receives data, such as energy management messages, between energy consumers 106 and one or more systems or components of the utility company. In the exemplary embodiment, energy consumers 106 are devices or systems, such as appliances, machines, lighting systems, security systems, computers, and/or any other load that consumes energy received from the utility.

In the exemplary embodiment, at least one AMI meter 108 is coupled to each network device 104 within or proximate to location 102. Moreover, in the exemplary embodiment, AMI meter 108 is coupled to each energy consumer 106 within location 102 via network device 104. In an alternative embodiment, location 102 does not include a network device 104, and AMI meter 108 is coupled directly to energy consumers 106 of location 102. In the exemplary embodiment, AMI meter 108 measures the energy consumed by each energy consumer 106 within location 102 and transmits data representative of the energy consumed (hereinafter referred to as “energy consumption measurements”) to a meter monitoring system 110, as described more fully below. Moreover, in the exemplary embodiment, AMI meters 108 are programmed to measure the energy consumed by each energy consumer 106 at a start of a billing cycle and at an end of the billing cycle and to store energy consumption measurements within a memory device (not shown) within each AMI meter 108. The billing cycle may be 30 days, a calendar month, and/or any other time period as desired. Moreover, in the exemplary embodiment, AMI meters 108 are enabled to measure and store power measurements periodically, such as every hour, every 10 minutes, and/or at any other frequency. AMI meters 108 are also enabled to measure energy consumption upon a request (i.e., “on demand”) that is initiated by a system coupled in signal communication with AMI meters 108. In the exemplary embodiment, AMI meters 108 are programmed to automatically transmit the measurements to meter monitoring system 110.

Moreover, a plurality of AMI meters 108, in the exemplary embodiment, are coupled to, and/or are a part of, an AMI system or network 112. Moreover, in the exemplary embodiment, AMI system 112 is coupled to meter monitoring system 110. In the exemplary embodiment, AMI system 112 includes a plurality of data and/or power conduits, such as network and/or power cables, that enable data to be transmitted and received between AMI meters 108 and meter monitoring system 110. Moreover, in the exemplary embodiment, AMI system 112 includes at least one computer, such as a server, and/or at least one router or switch that enables data to be routed to identified destinations.

As used herein, the term “computer” refers to a system that includes at least one processor and at least one memory device. The processor may include any suitable programmable circuit including one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.” A computer may include a plurality of processors and/or memory devices, and may be, or may be included within, one or more servers, data centers, and/or any other centralized or distributed computing system. Moreover, in the exemplary embodiment, the memory device includes a computer-readable medium, such as, without limitation, random access memory (RAM), flash memory, a hard disk drive, a solid state drive, a diskette, a flash drive, a compact disc, a digital video disc, and/or any suitable memory that enables the processor to store, retrieve, and/or execute instructions and/or data.

In one embodiment, AMI system 112 may be coupled to at least one legacy meter (not shown) instead of, or in addition to, AMI meter 108. As used herein, the term “legacy” refers to a meter or another device that does not include the capability of remotely communicating with and/or being remotely controlled by another device. In contrast, AMI meters 108, or “smart meters,” are enabled to remotely communicate with and/or be remotely controlled by another device or system, such as meter monitoring system 110, a demand response system 114, and/or any other device or system that enables system 100 to function as described herein.

Meter monitoring system 110, in the exemplary embodiment, includes at least one computer that is located at the utility company, such as within a data center (not shown) of the utility company. Alternatively, meter monitoring system 110 is located external to the utility company, and system 110 may be coupled in communication with a computer or other device (not shown) at the utility company. In the exemplary embodiment, meter monitoring system 110 receives energy consumption measurements from AMI meters 108 and stores the energy consumption measurements on one or more data files (not shown) associated with each AMI meter 108.

System 100 also includes demand response system 114, in the exemplary embodiment, that is coupled to meter monitoring system 110 via a system bus 116. In the exemplary embodiment, system bus 116 at least partially forms an intranet or other network within the utility company that enables data to be transmitted and received securely between a plurality of computers 118. In the exemplary embodiment, computers 118 include, or are included within, meter monitoring system 110, demand response system 114, a customer information system 120, and a billing system 122. Alternatively, computers 118 may include, or may be included within, any other system or systems that enables system 100 to function as described herein. In the exemplary embodiment, computers 118 are housed within a data center (not shown) of the utility company. Alternatively, computers 118 may be housed in any other location that enables systems 118 to communicate with each other and with the utility company. Moreover, while computers 118 are described herein as having separate functions, inputs, and/or outputs, it should be recognized that any computer 118 may include the functionality of any other computer 118, and/or may be combined with any other computer 118.

Demand response system 114, in the exemplary embodiment, generates, receives, and/or stores information relating to critical peak events and/or critical peak pricing events that may be identified and/or received by the utility company. As used herein, the terms “critical peak” and “critical peak events” refer to periods of time and/or events that may occur within a power distribution network or grid where a shortage of power generation and/or power transmission capacity occurs (i.e., where demand for power exceeds the utility company's ability to supply the demanded power to each utility customer). As used herein, the term “critical peak pricing event” refers to a period of time where a price or rate for energy supplied to a customer is changed, such as increased, as a result of a critical peak event.

In the exemplary embodiment, demand response system 114 determines when a critical peak pricing event will be initiated, and transmits a notification of the critical peak pricing event to the customers and/or to agents of the customers who will be affected by the event, such as those customers who are enrolled in a flat rate billing plan that includes critical peak pricing superimposed on the flat rate. The critical peak pricing event notification includes, in the exemplary embodiment, a start time for the critical peak pricing event, a duration and/or an end time for the critical peak pricing event, and a price and/or a price adjustment for energy consumed during the critical peak pricing event. Demand response system 114 causes the critical peak pricing event notifications to be transmitted to the customers and/or to agents of the customers, and stores the data contained in the notifications in one or more log files and/or other files. Moreover, in the exemplary embodiment, demand response system 114 transmits a critical peak pricing signal to billing system 122 and/or to any other computer 118. The critical peak pricing signal is representative of the price and/or the price adjustment for energy consumed by energy consumer 106 during the critical peak pricing event.

In the exemplary embodiment, demand response system 114 also transmits requests to AMI meters 108 that cause AMI meters 108 to measure energy consumption by energy consumers 106. Such requests, in the exemplary embodiment, are transmitted through meter monitoring system 110 and through AMI system 112 to AMI meters 108. Moreover, in the exemplary embodiment, at least some requests are transmitted on-demand (i.e., not on a predefined schedule), and are timed such that AMI meters 108 measure the energy consumption of energy consumers 106 at the beginning of the critical peak pricing event and at the end of the critical peak pricing event. In an alternative embodiment, demand response system 114 may transmit the requests at the beginning and end of the critical peak pricing events and at the beginning and end of the billing cycle, and/or at any other time, frequency, or schedule.

In one embodiment, demand response system 114 also initiates load control events. As used herein, the term “load control event” refers to a message and/or a signal transmitted from a system to an energy consumer 106, network device 104, and/or AMI meter 108 for use in reducing and/or halting energy consumption by energy consumer 106. As such, demand response system 114 may cause energy consumers 106 to be de-energized when energy demand exceeds energy production and/or energy transmission capacity.

Customer information system 120, in the exemplary embodiment, is coupled to at least one other computer 118 via system bus 116. In the exemplary embodiment, customer information system 120 includes a database (not shown) and/or any other data structure that stores information relating to utility customers. The information includes, but is not limited to only including, the customer name, the residential address, email address, billing address, and/or any other contact information for the customer, the billing plan that the customer is subscribed to, and/or any other information that enables system 100 to function as described herein. In the exemplary embodiment, a subset of the customers listed within customer information system 120 are subscribed to a flat rate billing plan with critical peak pricing (hereinafter referred to as a “flat rate critical peak plan”) superimposed thereon. Alternatively, any number of customers are subscribed to the flat rate critical peak plan, and/or any other billing plan that enables system 100 to function as described herein.

In the exemplary embodiment, billing system 122 stores pricing rates and other terms and conditions for each customer's billing plan, such as for the flat rate critical peak plan. Alternatively, the pricing rates and/or other terms of the billing plan may be stored in customer information system 120, and signals representative of the pricing rates and/or the other billing plan terms may be transmitted to billing system 122. Moreover, in the exemplary embodiment, billing system 122 receives at least one pricing signal or pricing data from demand response system 114. More specifically, in the exemplary embodiment, billing system 122 receives a pricing signal or pricing data representative of a price of electricity consumed by each customer during a critical peak pricing event (hereinafter referred to as a “critical peak pricing signal”). Alternatively, billing system 122 receives a pricing signal or pricing data representative of a price adjustment that changes the price of electricity consumed by each customer during the critical peak pricing event. The price adjustment may include a price increase with respect to a flat pricing rate or a price decrease with respect to the flat pricing rate. In the exemplary embodiment, billing system 122 also receives energy consumption measurements from meter monitoring system 110. The measurements include the amount of energy consumed during each critical peak pricing event within a billing cycle or period and the amount of energy consumed other than during the critical peak pricing events (i.e., during the time periods before and/or after the critical peak pricing events have occurred). Based on the inputs received, billing system 122 generates a utility bill for each customer. Billing system 122 transmits the bill, or causes the bill to be transmitted, to each customer and/or to an agent of each customer. In one embodiment, billing system 122 transmits data representative of the bill to a communication system (not shown) that transmits the data to each customer via mail, via email, via a public switched telephone network (not shown), via a webpage, and/or via any other communication medium that enables system 100 to function as described herein.

Moreover, in the exemplary embodiment, a supervisory control and data acquisition (SCADA) system 124 is coupled to system bus 116. In the exemplary embodiment, SCADA system 124 is or includes a computer 118. SCADA system 124 controls an operation of a plurality of power distribution components (not shown) that may include, but are not limited to only including, at least one substation, feeder, transformer, and/or any other component that enables SCADA system 124 to function as described herein. SCADA system 124 is coupled to a plurality of sensors 126, such as current sensors, voltage sensors, and/or any other sensor, that measure operating characteristics of the power distribution components and/or operating characteristics of the power distribution network. Moreover, SCADA system 124 is coupled to a plurality of control devices 128, such as circuit breakers, voltage regulators, capacitor banks, and/or any other device that enables SCADA system 124 to control and/or adjust the operational characteristics of the power distribution network and/or the power distribution components. In the exemplary embodiment, SCADA system 124 is enabled to communicate with sensors 126 and control devices 128 to control the power distribution components using closed loop feedback.

In the exemplary embodiment, SCADA system 124 includes a software-based model or representation of the power distribution network (hereinafter referred to as a “network model”) stored within a memory device (not shown). Alternatively, the network model is stored within any other computer 118 that enables system 100 to function as described herein, such as, without limitation, within demand response system 114 and/or customer information system 120. In the exemplary embodiment, the network model enables SCADA system 124 to identify the topology and/or the interconnections of the power distribution components for use in controlling and/or monitoring the components.

During operation, in the exemplary embodiment, AMI meters 108 for each customer and/or location 102 transmit energy consumption measurements for each customer at the beginning of the billing cycle. If a shortage of power transmission and/or power generation capability occurs or is anticipated to occur, demand response system 114 prepares to issue a critical peak pricing event and identifies a subset of customers that are subscribed to the flat rate critical peak plan. The subset of customers may be identified using data from customer information system 120 and/or any other computer 118, including demand response system 114, that enables system 100 to function as described herein. Demand response system 114 identifies a start time, a duration and/or an end time, and a price and/or price adjustment for the critical peak pricing event. Demand response system 114 causes a notification of the critical peak pricing event to be transmitted to each agent and/or customer of the subset of customers. Each AMI meter 108 associated with each customer of the subset of customers transmits at least one energy consumption measurement at the start of the critical peak pricing event (i.e., once the start time is reached) and at the end of the critical peak pricing event (i.e., once the end time is reached or the duration has elapsed) to meter monitoring system 110. In the exemplary embodiment, demand response system 114 transmits one or more measurement requests to AMI meters 108 at the start time and at the end time of the critical peak pricing event, and AMI meters transmit the respective energy consumption measurements to meter monitoring system 110 in response to the requests. Alternatively, AMI meters 108 receive the critical peak pricing event notifications and are programmed by the notifications to automatically transmit the energy consumption measurements to meter monitoring system 110 once the start time and/or the end time is reached.

Meter monitoring system 110, in the exemplary embodiment, receives the energy consumption measurements and transmits the energy consumption measurements to billing system 122. Demand response system 114 transmits a critical peak pricing signal to billing system 122 to enable billing system 122 to determine the price for energy consumed during the critical peak pricing event. Moreover, in the exemplary embodiment, billing system 122 references data stored within billing system 122 to determine a price (hereinafter referred to as a “flat pricing rate”) for energy consumed during a flat rate period (i.e., during a time period other than the critical peak pricing event). Billing system 122 generates a bill for the energy consumed during the billing cycle using a billing algorithm (not shown in FIG. 1) stored within billing system 122. In the exemplary embodiment, billing system 122 transmits the bill to the customer and/or causes the bill to be transmitted to the customer and/or to the agent of the customer.

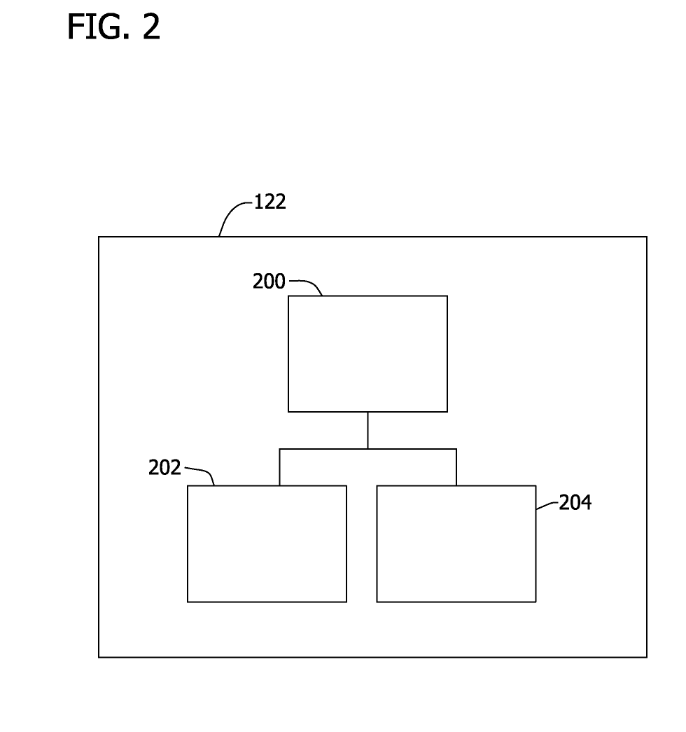

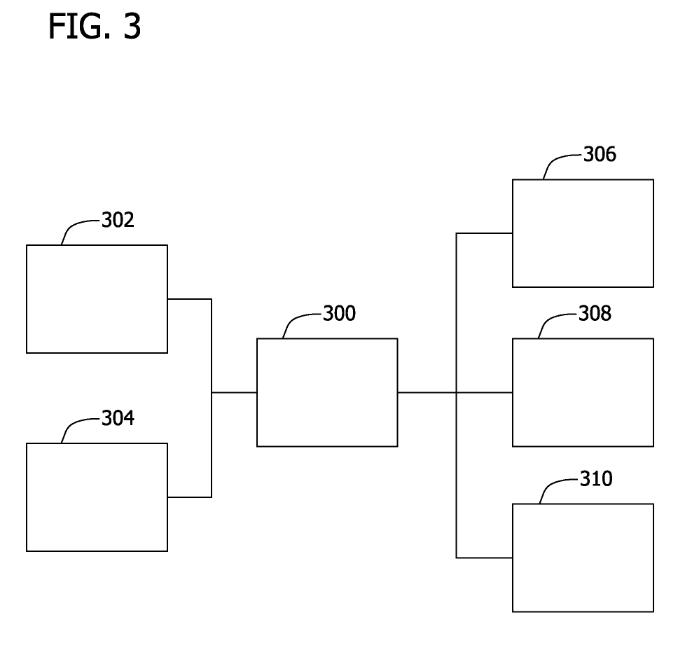

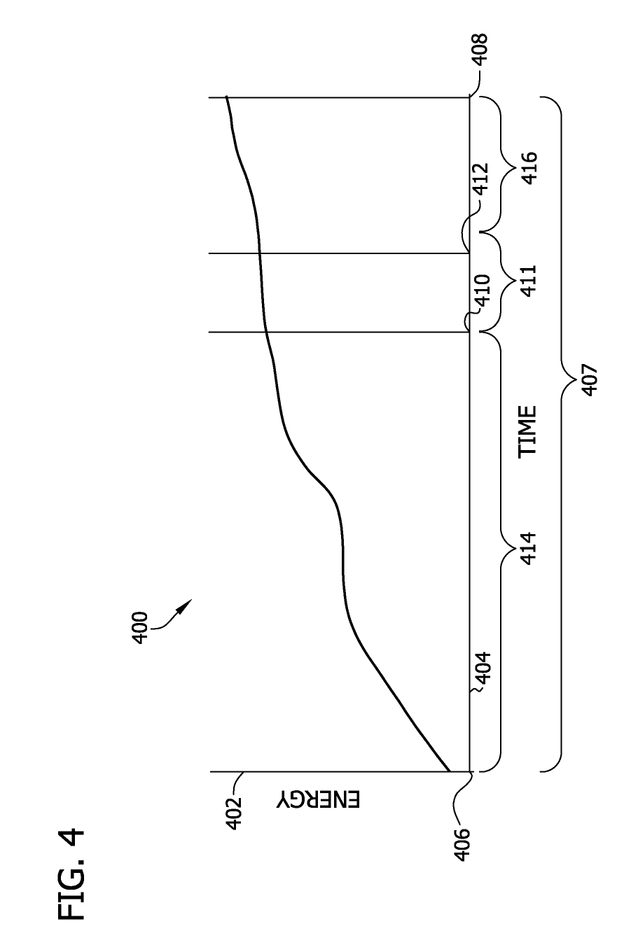

FIG. 2 is a block diagram of an exemplary billing system 122 that may be used with system 100 (shown in FIG. 1). FIG. 3 is a block diagram of an exemplary billing algorithm 300 that may be used with billing system 122. FIG. 4 is a graphical view of an exemplary energy consumption history 400 of a location 102 including at least one energy consumer 106.

In the exemplary embodiment, billing system 122 includes a processor 200, a network interface 202, and a memory device 204 that are coupled together. Processor 200 controls the operation of billing system 122 and generates a bill for a utility customer associated with, or responsible for, a location 102 and/or an energy consumer 106 (shown in FIG. 1), as described more fully herein. Network interface 202, in the exemplary embodiment, is coupled to system bus 116 for receiving data from computers 118, such as from demand response system 114 and from meter monitoring system 110 (each shown in FIG. 1). Moreover, network interface 202 transmits data, such as data representative of a bill, to one or more computers 118 and/or to any other system that enables system 100 to function as described herein. In the exemplary embodiment, network interface 202 includes a network adapter (not shown). Alternatively, network interface 202 includes any other device that enables billing system 122 to communicate with computers 118 via system bus 116. In the exemplary embodiment, memory device 204 is a computer-readable medium, such as random access memory (RAM). Alternatively, memory device 204 is any other computer-readable medium that enables data and/or instructions to be stored within memory device 204 for execution and/or other use by processor 200.

Billing algorithm 300, in the exemplary embodiment, is stored within memory device 204 and is executed by processor 200. Billing algorithm 300 receives at least one pricing input 302 from demand response system 114 (shown in FIG. 1) and at least one meter data input 304 from meter monitoring system 110 (shown in FIG. 1). Alternatively, pricing input 302 and/or meter data input 304 may be received from any other system or device that enables billing algorithm 300 to function as described herein. Pricing input 302, in the exemplary embodiment, includes a pricing signal and/or a pricing adjustment signal, such as a critical peak pricing signal, for use in determining a pricing rate for energy consumed during a critical peak pricing event (hereinafter referred to as the “critical peak pricing rate”). Moreover, in the exemplary embodiment, meter data input 304 includes energy consumption measurements representative of energy consumed during the critical peak pricing event, and energy consumption measurements representative of energy consumed other than during the critical peak pricing event, such as before and/or after the critical peak pricing event. Alternatively or additionally, pricing input 302 and/or meter data input 304 may include any other data that enables billing algorithm 300 to function as described herein.

Moreover, in the exemplary embodiment, billing algorithm 300 generates a bill 306 representative of a cost of energy consumed by each energy consumer 106 within location 102 during the billing cycle. In the exemplary embodiment, billing system 122 generates an alternative bill 308 for each energy consumer 106 within location 102 during the billing cycle. Alternative bill 308 represents an estimated cost for the energy consumed by each energy consumer 106 within location 102 if the utility customer is subscribed to an alternative billing plan, rather than the flat rate critical peak plan. In the exemplary embodiment, the flat rate critical peak plan includes a discounted flat pricing rate as compared to the pricing rate of the alternative billing plan. Accordingly, billing system 122 generates a report 310 that indicates a cost savings that the utility customer realizes by subscribing to the flat rate critical peak plan. Alternatively, if alternative bill 308 is lower than bill 306 (i.e., the cost of energy consumed under the alternative billing plan is lower than the cost of energy consumed under the flat rate critical peak plan), report 310 indicates the additional cost for the energy consumed under the flat rate critical peak plan as compared to the alternative billing plan. In such a situation, billing system 122 may cause alternative bill 308 to be transmitted to the customer instead of bill 306, thus ensuring that the customer always receives the bill with the lowest cost for the energy consumed. As such, the utility customer may be encouraged to subscribe to the flat rate critical peak plan, rather than subscribing to an alternative billing plan. In one embodiment, report 310 is incorporated within bill 306 and/or alternative bill 308.

Referring to FIG. 4, energy consumption history 400 represents a measured energy consumption 402 of a location 102 including at least one energy consumer 106 over a period of time 404. More specifically, AMI meters 108 (shown in FIG. 1) measure an amount of energy 402, such as a total amount of energy 402, consumed by each energy consumer 106. In the exemplary embodiment, AMI meters 108 transmit the energy consumption measurements to meter monitoring system 110 at specified times 404, such as at a beginning 406 of a billing cycle or period 407, at an end 408 of the billing period 407, at a beginning 410 of a critical peak pricing event 411, and at an end 412 of the critical peak pricing event 411. Alternatively or additionally, AMI meters 108 transmit the energy consumption measurements to meter monitoring system 110 at any other time 404 that enables billing algorithm 300 to function as described herein. In the exemplary embodiment, meter monitoring system 110 transmits the energy consumption measurements to billing system 122 for use by billing algorithm 300.

In the exemplary embodiment, billing algorithm 300 calculates an amount of energy consumed during a first period 414 by subtracting the measured energy consumption 402 at the beginning 406 of the billing period 407 from the measured energy consumption 402 at the beginning 410 of the critical peak pricing event 411. Moreover, billing algorithm 300 calculates an amount of energy consumed during a second period 416 by subtracting the measured energy consumption 402 at the end 412 of the critical peak pricing event 411 from the measured energy consumption 402 at the end 408 of the billing period 407. In the exemplary embodiment, first period 414 and second period 416 are billed at the flat pricing rate because they do not occur during the critical peak pricing event 411. Billing algorithm 300 calculates an amount of energy consumed during the critical peak pricing event 411 by subtracting the measured energy consumption 402 at the beginning 410 of the critical peak pricing event 411 from the measured energy consumption 402 at the end 412 of the critical peak pricing event 411. Billing algorithm 300, in the exemplary embodiment, multiplies the energy consumed during first period 414 and during second period 416 by the flat pricing rate, and multiplies the energy consumed during critical peak pricing event 411 by the critical peak pricing rate. Billing algorithm 300 determines the total cost of the energy consumed during the billing period by adding the multiplied quantities together. In the exemplary embodiment, billing algorithm 300 includes the total cost of the energy consumed in the generated bill 306. Moreover, in the exemplary embodiment, billing algorithm 300 calculates alternative bill 308 by subtracting the measured energy consumption 402 at the beginning 406 of the billing period 407 from the measured energy consumption 402 at the end 408 of the billing period 407, and multiplying the result by a predefined alternative pricing rate in accordance with the alternative billing plan.

Moreover, in one embodiment, the critical peak pricing rate is adjusted based on the measured energy consumption 402 during the critical peak pricing event 411. For example, in one embodiment, the critical peak pricing rate is increased if the measured energy consumption 402 exceeds a predetermined threshold (not shown) during the critical peak pricing event 411.

In another embodiment, a first energy consumption rate is calculated for the energy consumed during the critical peak pricing event 411. In such an embodiment, the first energy consumption rate may be calculated by dividing the energy consumed during the critical peak pricing event 411 by the duration of the critical peak pricing event 411. As such, an average energy consumption rate may be calculated for the critical peak pricing event 411 and may be used as the first energy consumption rate. Alternatively, a plurality of energy consumption measurements may be obtained from AMI meter 108 during the critical peak pricing event 411, and the first energy consumption rate may be calculated based on the plurality of energy consumption measurements and based on the duration of the critical peak pricing event 411. In a similar manner, a second energy consumption rate may be calculated for the energy consumed other than during the critical peak pricing event 411 (i.e., during the first period 414 and/or the second period 416). The critical peak pricing rate may be increased if the first energy consumption rate is higher than the second energy consumption rate (i.e., if energy consumers 106 consume energy at a higher rate during the critical peak pricing event 411 as compared to the energy consumption rate during the first period 414 and/or the second period 416). Moreover, the critical peak pricing rate may be decreased if the first energy consumption rate is lower than the second energy consumption rate. As such, a customer may be encouraged to reduce energy consumption during critical peak pricing events 411.

The exemplary system described herein provides a robust and efficient billing system that provides a flat rate billing plan with critical peak pricing. A meter associated with an energy consumer measures energy consumed at the beginning of a billing cycle and at the end of the billing cycle. If a critical peak pricing event occurs during the billing cycle, the meter measures energy consumed at the beginning of the critical peak pricing event and energy consumed at the end of the critical peak pricing event. The meter transmits the energy measurements to a billing system via a meter monitoring system. A demand response system transmits pricing information to the billing system for use in determining a cost of energy consumed during the critical peak pricing event. The billing system calculates the cost of energy consumed during the billing cycle by combining the cost of energy consumed during one or more flat rate billing periods with the cost of energy consumed during one or more critical peak pricing events. The billing system generates a bill that includes the cost of energy consumed, and generates an alternative bill that identifies a cost of the energy consumed under an alternative billing plan. The billing system generates a report comparing the bill and the alternative bill, and may transmit the lower of the bill and the alternative bill to the customer. Accordingly, a customer may be incentivized to enroll in a flat rate billing plan with critical peak pricing such that energy may be reduced during critical peak pricing events. Moreover, with such a billing plan, energy may be charged to the customer at higher rates during the critical peak pricing events to better account for additional energy generation and/or transmission costs.

A technical effect of the systems and method described herein includes at least one of (a) receiving a signal representative of a critical peak pricing rate for energy consumed during a critical peak pricing event; (b) determining an amount of energy consumed by an energy consumer during a critical peak pricing event; (c) determining an amount of energy consumed by an energy consumer other than during a critical peak pricing event; and (d) generating a bill, wherein the bill includes a flat pricing rate for a first amount of energy consumed and a critical peak pricing rate for a second amount of energy consumed.

Exemplary embodiments of systems and methods for use in generating a bill are described above in detail. The systems and methods are not limited to the specific embodiments described herein, but rather, components of the systems and/or steps of the methods may be utilized independently and separately from other components and/or steps described herein. For example, the billing algorithm described herein may also be used in combination with other energy systems and methods, and is not limited to practice with only the system as described herein. Rather, the exemplary embodiment can be implemented and utilized in connection with many other utility and/or energy applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a meter for monitoring energy consumed by an energy consumer;
a first computer coupled to said meter, said first computer configured to receive from said meter a plurality of measurements representative of energy consumed during a billing period;
a second computer configured to generate a signal representative of a critical peak pricing rate for energy consumed during a critical peak pricing event; and
a third computer coupled to said first computer and to said second computer, said third computer configured to:
calculate a first consumption amount representative of energy consumed during the critical peak pricing event from the plurality of measurements;
calculate a second consumption amount representative of energy consumed other than during the critical peak pricing event from the plurality of measurements; and,
generate a bill, wherein the bill includes a flat pricing rate for the second consumption amount and the critical peak pricing rate for the first consumption amount.

2. A system in accordance with claim 1, wherein the critical peak pricing rate is dependent on the first consumption amount.

3. A system in accordance with claim 1, wherein the critical peak pricing rate increases if the first consumption amount exceeds a predetermined threshold.

4. A system in accordance with claim 1, wherein said third computer is further configured to calculate a first energy consumption rate during the critical peak pricing event and a second energy consumption rate other than during the critical peak pricing event, and wherein the critical peak pricing rate increases if the first energy consumption rate increases with respect to the second energy consumption rate.

5. A system in accordance with claim 1, wherein said third computer is further configured to calculate a first energy consumption rate during the critical peak pricing event and a second energy consumption rate other than during the critical peak pricing event, and wherein the critical peak pricing rate decreases if the first energy consumption rate decreases with respect to the second energy consumption rate.

6. A system in accordance with claim 1, wherein said second computer is further configured to cause a notification of the critical peak pricing event to be transmitted to at least one of a utility customer and an agent of the utility customer.

7. A system in accordance with claim 1, wherein said third computer is configured to:
generate an alternative bill based on a billing plan that does not include the critical peak pricing rate; and
compare the alternative bill with the bill that includes the critical peak pricing rate.

8. A system in accordance with claim 7, wherein said third computer is configured to cause the lower of the alternative bill and the bill that includes the critical peak pricing rate to be transmitted to at least one of a utility customer and an agent of the utility customer.

9. A billing system, comprising:
a processor configured to:
receive a plurality of measurements representative of energy consumed during a billing period;
receive a signal representative of a critical peak pricing rate for energy consumed during a critical peak pricing event;
calculate a first consumption amount representative of energy consumed by an energy consumer during the critical peak pricing event from the plurality of measurements;
calculate a second consumption amount representative of energy consumed by the energy consumer other than during the critical peak pricing event from the plurality of measurements; and
generate a bill, wherein the bill includes a flat pricing rate for the second consumption amount and the critical peak pricing rate for the first consumption amount.

10. A billing system in accordance with claim 9, wherein the critical peak pricing rate is dependent on the first consumption amount.

11. A billing system in accordance with claim 9, wherein the critical peak pricing rate increases if the first consumption amount exceeds a predetermined threshold.

12. A billing system in accordance with claim 9, further configured to calculate a first energy consumption rate during the critical peak pricing event and a second energy consumption rate other than during the critical peak pricing event, and wherein the critical peak pricing rate increases if the first energy consumption rate increases with respect to the second energy consumption rate.

13. A billing system in accordance with claim 9, further configured to calculate a first energy consumption rate during the critical peak pricing event and a second energy consumption rate other than during the critical peak pricing event, and wherein the critical peak pricing rate decreases if the first energy consumption rate decreases with respect to the second energy consumption rate.

14. A billing system in accordance with claim 9, further configured to:
generate an alternative bill based on a billing plan that does not include the critical peak pricing rate; and
compare the alternative bill with the bill that includes the critical peak pricing rate to determine the lower of the alternative bill and the bill that includes the critical peak pricing rate.

15. A method for generating a bill, said method comprising:
receiving a signal representative of a critical peak pricing rate for energy consumed during a critical peak pricing event, via a processor;
determining a first amount of energy consumed by an energy consumer during the critical peak pricing event, via the processor;
determining a second amount of energy consumed by the energy consumer other than during the critical peak pricing event, via the processor; and
generating a bill, via the processor, wherein the bill includes a flat pricing rate for the first amount and the critical peak pricing rate for the second amount.

16. A method in accordance with claim 15, further comprising adjusting the critical peak pricing rate based on the first amount, via the processor.

17. A method in accordance with claim 15, further comprising increasing the critical peak pricing rate if the first amount exceeds a predetermined threshold, via the processor.

18. A method in accordance with claim 15, further comprising:
calculating a first energy consumption rate during the critical peak pricing event and a second energy consumption rate other than during the critical peak pricing event, via the processor; and
increasing the critical peak pricing rate if the first energy consumption rate increases with respect to the second energy consumption rate, via the processor.

19. A method in accordance with claim 15, further comprising:
calculating a first energy consumption rate during the critical peak pricing event and a second energy consumption rate other than during the critical peak pricing event, via the processor; and
decreasing the critical peak pricing rate if the first energy consumption rate decreases with respect to the second energy consumption rate, via the processor.

20. A method in accordance with claim 15, further comprising:
generating an alternative bill based on a billing plan that does not include the critical peak pricing rate, via the processor; and
comparing the alternative bill with the bill that includes the critical peak pricing rate to determine the lower of the alternative bill and the bill that includes the critical peak pricing rate, via the processor.
